(19) United States
(12) Patent Application Publication
(10) Pub. No.: US 2025/0274931 A1
(43) Pub. Date: Aug. 28, 2025

(54) UE POWER SAVING MECHANISM

(71) Applicant: Nokia Technologies Oy, Espoo (FI)

(72) Inventors: Samuli Heikki TURTINEN, Oulu (FI); Chunli WU, Beijing (CN); Jussi-Pekka KOSKINEN, Oulu (FI)

(21) Appl. No.: 18/861,989

(22) PCT Filed: May 5, 2022
(86) PCT No.: PCT/CN2022/091019

§ 371 Date: Oct. 31, 2024

(51) Int. Cl. H04W 72/1263; H04W 52/02; H04W 72/115

(52) U.S. Cl. CPC H04W 72/1263; H04W 52/0235; H04W 72/115

(57) ABSTRACT

Embodiments of the present disclosure relate to devices, methods, apparatuses and computer readable storage media for UE power saving. According to embodiments of the present disclosure, a terminal device determines whether to monitor physical downlink control channel (PDCCH) from at least one serving cell based on a characteristic of the at least one serving cell associated with an uplink of the at least one serving cell if a scheduling request is triggered or a scheduling request is transmitted. In this way, there is no need to monitor PDCCH from all serving cells and thus the UE power saving can be achieved.

### TECHNICAL FIELD

Embodiments of the present disclosure generally relate to the field of telecommunications, and in particular, to devices, methods, apparatuses and computer readable media for UE power saving.

### BACKGROUND

In the third Generation Partnership Projection (3GPP) standardization for New Radio (NR), power saving of user equipment (UE) is a big concern. There are enhancements on power saving techniques. For example, physical downlink control channel (PDCCH) skipping functionality has been agreed in Release 17.

UE power saving may be achieved through PDCCH skipping mechanism when configured by the network. In this case, UE does not monitor PDCCH during a PDCCH skipping duration. However, in some cases, UE needs to ignore the PDCCH skipping configuration.

### SUMMARY

In general, example embodiments of the present disclosure provide devices, methods, apparatuses and computer readable media for UE power saving.

In a first aspect, there is provided a terminal device. The terminal device comprises at least one processor; and at least one memory including computer program code; where the at least one memory and the computer program code are configured to, with the at least one processor, cause the terminal device to: in accordance with a determination that a scheduling request is triggered or a scheduling request is transmitted, determine whether to monitor physical downlink control channel (PDCCH) from at least one serving cell based on a characteristic of the at least one serving cell associated with an uplink of the at least one serving cell.

In a second aspect, there is provided a network device. The network device comprises at least one processor; and at least one memory including computer program code; where the at least one memory and the computer program code are configured to, with the at least one processor, cause the network device to: in accordance with a reception of a scheduling request from a terminal device, transmit, to the terminal device, an uplink grant over a physical downlink control channel (PDCCH) on a serving cell by ignoring PDCCH skipping on the serving cell.

In a third aspect, there is provided a method. The method comprises: in accordance with a determination that a scheduling request is triggered or a scheduling request is transmitted, determining, at a terminal device, whether to monitor physical downlink control channel (PDCCH) from at least one serving cell based on a characteristic of the at least one serving cell associated with an uplink of the at least one serving cell.

In a fourth aspect, there is provided a method. The method comprises: in accordance with a reception of a scheduling request from a terminal device, transmitting, from a network device and to the terminal device, an uplink grant over a physical downlink control channel (PDCCH) on a serving cell by ignoring PDCCH skipping on the serving cell.

In a fifth aspect, there is provided an apparatus. The apparatus comprises means for in accordance with a determination that a scheduling request is triggered or a scheduling request is transmitted, determining whether to monitor physical downlink control channel (PDCCH) from at least one serving cell based on a characteristic of the at least one serving cell associated with an uplink of the at least one serving cell.

In a sixth aspect, there is provided an apparatus. The apparatus comprises means for in accordance with a reception of a scheduling request from a terminal device, transmitting, to the terminal device, an uplink grant over a physical downlink control channel (PDCCH) on a serving cell by ignoring PDCCH skipping on the serving cell.

In a seventh aspect, there is a computer readable storage medium comprising program instructions stored thereon. The instructions, when executed by an apparatus, cause the apparatus to perform the method according to the above third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example environment in which example embodiments of the present disclosure may be implemented;

FIG. 2 illustrates a signalling chart illustrating an example process according to some example embodiments of the present disclosure;

FIG. 3 illustrates a signalling chart illustrating an example process according to some example embodiments of the present disclosure;

FIG. 4 illustrates a schematic diagram of serving cells according to some example embodiments of the present disclosure;

FIG. 5 illustrates a flowchart of an example method according to some example embodiments of the present disclosure;

FIG. 6 illustrates a flowchart of an example method according to some example embodiments of the present disclosure;

FIG. 7 illustrates a simplified block diagram of a device that is suitable for implementing embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), New Radio (NR) and so on. Furthermore, the communications between a UE and a network device or communications between network devices in the communication network may be performed according to any suitable communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a UE accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), an integrated access and backhaul (IAB) node, a relay, a low power node such as a femto, a pico, and so forth, depending on the applied terminology and technology. In the following description, the terms “network device”, “BS”, and “node” may be used interchangeably.

The term “terminal device” or “user equipment (UE)” refers to any end device that may be capable of wireless communication with each other or with the network device. By way of example rather than limitation, a UE may also be referred to as a communication device, terminal device, a Subscriber Station (SS), a Portable Subscriber Station, a Mobile Station (MS), or an Access Terminal (AT). The UE may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), Universal Serial Bus (USB) dongles, smart devices, wireless customer-premises equipment (CPE), an Internet of Things (IoT) device, a watch or other wearable, a head-mounted display (HMD), a vehicle, a drone, a medical device and applications (e.g., remote surgery), a UE-type rode side unit (RSU), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As described above, in the 3GPP standardization, there are some discussions about enhancements on power saving techniques. For example, one of downlink control information (DCI) based technologies for active time power saving considered in power saving is PDCCH monitoring adaptation. The PDCCH monitoring adaptation comprises search space set group (SSSG) switching and PDCCH skipping. In the SSSG switching, the configured search space (SS) sets can be assigned to groups, where one group can be activated based on DCI indication and/or timer, so that the UE monitors PDCCH in the SS set belonging to an active group. In the PDCCH skipping, the UE can be indicated based on the DCI to stop PDCCH monitoring for a configured duration. Specifically, when a PDCCH skipping duration is configured by the network, and the PDCCH skipping is indicated with the DCI to stop PDCCH monitoring for the duration, UE does not monitor PDCCH and thus the power saving may be achieved.

However, UE needs to ignore the PDCCH skipping in some cases, for example, UE ignores PDCCH skipping on all serving cells of corresponding cell groups while a scheduling request (SR) is pending. Although the ignoring mechanism may helpful to uplink transmission of the UE, it may not be beneficial for the UE power saving. Thus, there is a need to determine which serving cells on which the PDCCH skipping is ignored.

Example embodiments of the present disclosure provide a solution for UE power saving, in some example embodiments, the terminal device monitors PDCCH from only some but not all serving cells. In the present disclosure, it is determined that whether to monitor PDCCH at least based on a characteristic of the serving cell associated with an uplink of the terminal device. In some example embodiments, the serving cell without uplink configuration may not be monitored by the terminal device if a scheduling request is pending or a scheduling request is transmitted. Therefore, the UE power saving can be achieved.

### Example Environments

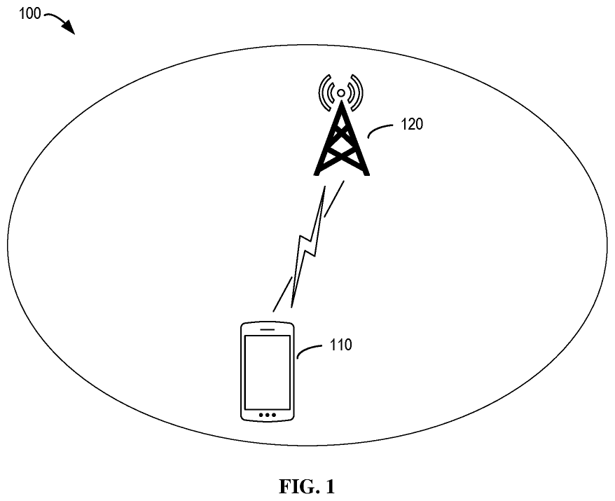

FIG. 1 shows an example environment 100 in which example embodiments of the present disclosure can be implemented. The environment 100, which may be a part of a communication network, includes a terminal device 110 and a network device 120 communicating with each other.

It is to be understood that two devices are shown in the environment 100 only for the purpose of illustration, without suggesting any limitation to the scope of the present disclosure. In some example embodiments, the environment 100 may comprise a further device to communicate with the terminal device 110 and/or the network device 120.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

In the example environment 100, the network device 120 can communicate/transmit data and control information to the terminal device 110, and the terminal device 110 can also communicate/transmit data and control information to the network device 120. A link from the network device 120 to the terminal device 110 is referred to as a downlink (DL), while a link from the terminal device 110 to the network device 120 is referred to as an uplink (UL). DL may comprise one or more logical channels, including but not limited to a Physical Downlink Control Channel (PDCCH) and a Physical Downlink Shared Channel (PDSCH). UL may comprise one or more logical channels, including but not limited to a Physical Uplink Control Channel (PUCCH) and a Physical Uplink Shared Channel (PUSCH). As used herein, the term “channel” may refer to a carrier or a part of a carrier consisting of a contiguous set of resource blocks (RBs) on which a channel access procedure is performed in shared spectrum.

Example embodiments of the present disclosure relate to the communication between the terminal device 110 and the network device 120. It is to be understood that FIG. 1 is shown merely for the purpose of illustration without suggesting any limitation to the protection scope. Some example embodiments are now detailed below with reference to FIG. 1.

### Example Processes

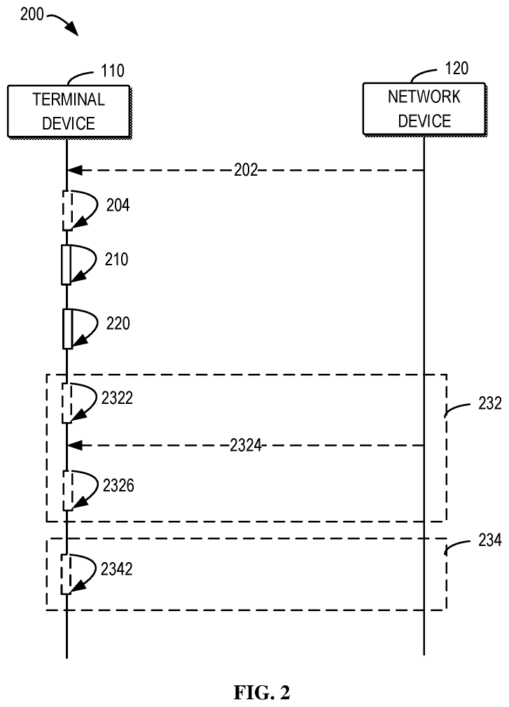

FIG. 2 illustrates a signalling chart illustrating an example process 200 according to some example embodiments of the present disclosure. For the purpose of discussion, the process 200 will be described with reference to FIG. 1.

The terminal device 110 determines 210 whether a condition for monitoring PDCCH is met. In some embodiments, the condition may be a scheduling request is triggered, or may be a scheduling request is transmitted. In some example embodiments, the scheduling request is triggered can also be called as the scheduling request is pending until cancelled.

The terminal device 110 determines 220 whether to monitor PDCCH from at least one serving cell if the condition is met. The determination is made based at least on a characteristic of the at least one serving cell.

In some embodiments, there is a plurality of serving cells. For each of the plurality of serving cells, the terminal device 110 may determine whether to monitor PDCCH from the serving cell.

In some example embodiments, as shown at 232 in FIG. 2, the terminal device 110 monitors 2322 PDCCH from the at least one serving cell if the characteristic of the at least one serving cell corresponds to at least one of the following:
(1) a serving cell with a configured uplink,
(2) a serving cell with a physical uplink shared channel (PUSCH) configuration,
(3) a serving cell which provides an uplink grant over a monitored PDCCH, or
(4) a serving cell with a PDCCH which is associated with another serving cell with a configured uplink or a PUSCH configuration.

In some examples, a serving cell with a configured uplink may refer to a serving cell which is configured with an uplink carrier. For example, the PDCCH of a downlink carrier of the serving cell provides UL grant(s) for the uplink carrier. In some examples, a serving cell with a physical uplink shared channel (PUSCH) configuration may refer to a serving cell which is configured with an uplink carrier and the PUSCH configuration is configured for the uplink carrier. For example, the PDCCH of a downlink carrier of the serving cell provides UL grant(s) for the uplink carrier with PUSCH configuration. In some examples, a serving cell which provides an uplink grant over a monitored PDCCH may refer to a serving cell with a downlink carrier. For example, such a serving cell may have only downlink carrier; or may have both downlink carrier and uplink carrier; or may have both downlink carrier and uplink carrier and further have a PUSCH configuration. For example, such a serving cell may provide UL grant(s) for an uplink carrier of the same serving cell; or may provide UL grant(s) for an uplink carrier with a PUSCH configuration of the same serving cell; or may provide UL grant(s) for an uplink carrier of another serving cell; or may provide UL grant(s) for an uplink carrier with a PUSCH configuration of another serving cell. That is, the serving cell may provide UL grant(s) for the serving cell or for another serving cell (which may be referred to as cross-scheduling). In some examples, a serving cell with a PDCCH which is associated with another serving cell with a configured uplink or a PUSCH configuration may refer to a serving cell which provides UL grant(s) for another serving cell. For example, such a serving cell may have a downlink carrier with PDCCH and may or may not have an uplink carrier.

Alternatively, or in addition, in some example embodiments, the terminal device 110 may receive 202 a PDCCH skipping configuration associated with the at least one serving cell where the PDCCH skipping configuration may include or indicate a predetermined time duration for the PDCCH skipping. Further, the terminal device 110 may apply or perform 204 the PDCCH skipping according to the PDCCH skipping configuration for the predetermined time duration. In some examples, the PDCCH skipping configuration may be terminal device 110 specific. For example, the PDCCH skipping configuration and the predetermined time duration are indicated for the terminal device 110 and applied for each serving cell configured for the terminal device 110. In some examples, the PDCCH skipping configuration may be serving cell specific. For example, the PDCCH skipping configuration and the predetermined time duration are indicated for each serving cell separately and applied for the given serving cell configured for the terminal device 110. In some examples, the PDCCH skipping configuration may be bandwidth part (BWP) specific of each BWP of a serving cell. For example, the PDCCH skipping configuration and the predetermined time duration are indicated for each or subset of BWPs of a serving cell separately and applied for the given BWP of the serving cell configured for the terminal device 110. In the following part of the description, a serving cell which is configured with PDCCH skipping may refer to any pre-defined configuration option.

In some examples, the at least one serving cell may have been configured with PDCCH skipping, and the terminal device 110 may monitor PDCCH from the at least one serving cell by ignoring the PDCCH skipping. In other words, the terminal device 110 can monitor PDCCH form the at least one serving cell even within the predetermined time duration. The process of applying or performing the PDCCH skipping on the at least one serving cell is terminated.

For example, as for a first serving cell, the terminal device 110 may determine to monitor PDCCH from the first serving cell if the first serving cell is one of the serving cells in (1)-(4) shown above. And further the terminal device 110 may monitor PDCCH from the first serving cell.

Alternatively, or in addition, in some example embodiments, the terminal device 110 receives 2324 an uplink grant from the monitored PDCCH from one serving cell of the at least one serving cell. And the terminal device 110 may perform an uplink transmission based on the uplink grant.

Alternatively, or in addition, in some example embodiments, the terminal device 110 may continue 2326 monitoring PDCCH from the at least one serving cell if an uplink grant is received or if an uplink transmission is performed. In some examples where PDCCH skipping is configured on the at least one serving cell, the terminal device 110 may continue to monitor PDCCH from the at least one serving cell by ignoring the PDCCH skipping.

Therefore, based on the embodiments in the present disclosure, the terminal device 110 may monitor PDCCH from the at least one serving cell if a SR is pending or a SR is transmitted, and thus the uplink transmission can be guaranteed.

In some example embodiments, as shown at 234 in FIG. 2, the terminal device 110 does not monitor 2342 PDCCH from the at least one serving cell if the characteristic of the at least one serving cell does not correspond to any one of the serving cells in (1)-(4) shown above. In some examples, the at least one serving cell may have been configured PDCCH skipping, and the terminal device 110 may not monitor PDCCH from the at least one serving cell by applying or performing the PDCCH skipping. In other words, the terminal device 110 continues to apply or perform the PDCCH skipping as long as within the predetermined time duration.

For example, as for a second serving cell, the terminal device 110 may determine not to monitor PDCCH from the second serving cell if the second serving cell is not any one of the serving cells in (1)-(4) shown above.

Alternatively, or in addition, in some example embodiments, the terminal device 110 may monitor PDCCH from the at least one serving cell if an uplink grant is received from a serving cell rather the at least one serving cell or if an uplink transmission is performed. In some examples where PDCCH skipping is configured on the at least one serving cell, the terminal device 110 may monitor PDCCH from the at least one serving cell by ignoring the PDCCH skipping. In other words, as long as the terminal device 110 receives an uplink grant from a serving cell (does not belong to the at least one serving cell) or performs an uplink transmission, the terminal device 110 can monitor PDCCH from all serving cells, even still within the predetermined time duration.

Alternatively, or in addition, in some example embodiments, the terminal device 110 may continue not monitoring PDCCH from the at least one serving cell even if an uplink grant is received from a serving cell rather the at least one serving cell or an uplink transmission is performed. In some examples where PDCCH skipping is configured on the at least one serving cell, the terminal device 110 may continue to apply or perform PDCCH skipping and not monitor PDCCH from the at least one serving cell. In other words, the terminal device 110 may apply or perform the PDCCH skipping as long as the predetermined time duration has not expired, that is, a reception of an uplink grant or an uplink transmission does not affect the PDCCH skipping on the at least one serving cell.

Therefore, based on the embodiments in the present disclosure, the terminal device 110 does not monitor PDCCH from the at least one serving cell regardless of the pending SR, and thus the UE power saving can be achieved.

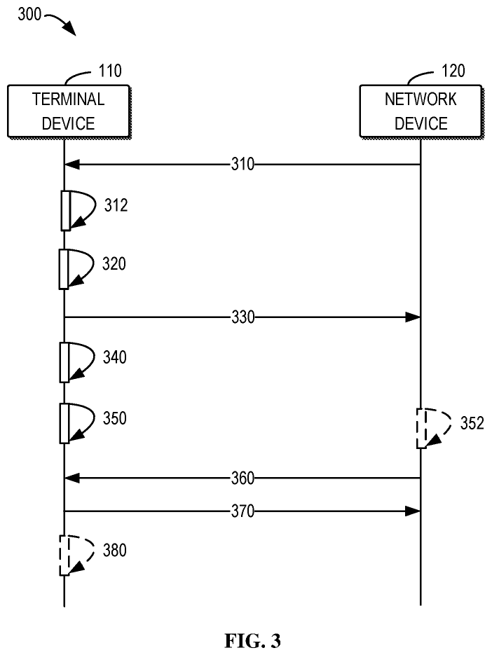

Reference is now made to FIG. 3. FIG. 3 illustrates a signalling chart illustrating an example process 300 according to some example embodiments of the present disclosure. For the purpose of discussion, the process 300 will be described with reference to FIG. 1.

The network device 120 configures 310 PDCCH skipping associated with the serving cell(s) for the terminal device 110. Alternatively or in addition, the network device 120 may configure carrier aggregation for the terminal device 110.

In some example embodiments, the PDCCH skipping may be configured per UE, or per serving cell, or per bandwidth part (BWP) of the serving cell. In some examples, PDCCH skipping commands may be transmitted per serving cell. For instance, each serving cell may indicate the PDCCH skipping on the serving cell itself by corresponding DCI.

In some example embodiments, the network device 120 may transmit a PDCCH skipping configuration including an indication of predetermined time duration to the terminal device 110. Accordingly, the terminal device 110 applies or performs 312 the PDCCH skipping according to the PDCCH skipping configuration for the predetermined time duration.

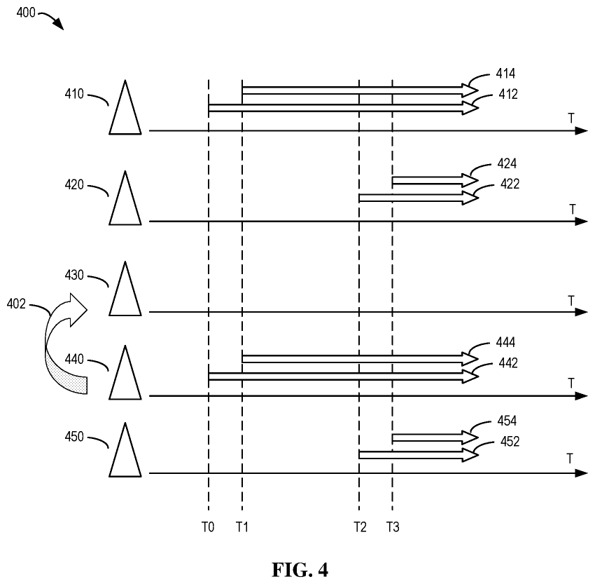

For ease of description, it is assumed that there are 5 serving cells. FIG. 4 illustrates a schematic diagram of serving cells 400 according to some embodiments of the present disclosure. The serving cells in FIG. 4 include serving cells 410-450, in which serving cell 410 is a primary cell and serving cells 420-450 are secondary cells.

For the uplink transmissions from the terminal device 110, the serving cell 410 has configured PUCCH resources and configured PUSCH resources; the serving cell 420 has configured PUCCH resources but does not have configured PUSCH resources; the serving cell 430 has configured PUSCH resources, the serving cell 440 does not have configured uplink resources but has downlink resources which are scheduling 402 the PUSCH transmissions to the serving cell 430; and the serving cell 450 does not have any uplink resources (PUCCH resources or PUSCH resources) for the terminal device 110.

In some embodiments, the serving cell 450 may refer to a serving cell with DL only configuration. In some embodiments, the serving cell 440 may refer to a serving cell with DL only configuration and configured to schedule the serving cell 430 with UL carrier. In some embodiments, the serving cell 420 may refer to a serving cell with no PUSCH.

In some embodiments, at process 310, the PDCCH skipping configurations may be transmitted by serving cells 410, 420, 440 and 450 respectively. It is understood that since the serving cell 430 has no configured PDCCH resources, there is no PDCCH skipping configuration from the serving cell 430.

It is appreciated that the terminal device 110 will not monitor PDCCH from serving cells 410-450, based on these PDCCH skipping configurations.

It is to be understood that the numbers of serving cells and their configurations shown in FIG. 4 are only for the purpose of illustration without suggesting any limitation, and the embodiments can also be applied to other scenarios other than that shown in FIG. 4. The number of serving cell(s) may be any suitable number adapted for implementing embodiments of the present disclosure.

Alternatively, or in addition, in some example embodiments, the PDCCH skipping configuration at 310 may comprise an indication of a predetermined time duration for the PDCCH skipping. The predetermined time duration may be used to indicate a time period within which the PDCCH skipping is valid.

Still referring to FIG. 3, SR is triggered 320 at the terminal device 110 and then the terminal device 110 sends 330 a SR to the network device 120.

A scheduling request (SR) is used for requesting uplink shared channel resources for new transmission. For example, the MAC entity may be configured with zero, one, or more scheduling request configurations. A scheduling request configuration consists of a set of PUCCH resources for the scheduling request across different bandwidth parts (BWPs) and cells. For beam failure recovery or for LBT failure recovery, at most one PUCCH resource for the scheduling request may be configured per BWP.

In some embodiments, SR is triggered at the terminal device 110 for example if: there is a buffer status report to be transmitted to the network device, or there is occurrence of beam failure recovery or a failure of a listen before talk (LBT) procedure.

It is noted that the term “when SR is triggered” may refer to “while SR is pending” in some cases, and SR may not be pending after it is transmitted.

The terminal device 110 determines 340 one or more serving cells from, for example, all serving cells. In some embodiments, the uplink scheduling configurations of the plurality of serving cells are considered. Specifically, the one or more serving cells may be determined based on the uplink scheduling statuses of the at least one serving cell. In some example embodiments, the uplink scheduling statuses may refer to types of uplink.

In some embodiments, the determination 340 may be performed after the process 320 or 330. In other words, the terminal device 110 determines one or more serving cells if the SR is trigged (or SR is pending) or if the SR is transmitted.

In some example embodiments, if a first serving cell is configured with uplink scheduling information for the terminal device 110, the terminal device 110 may determine that the one or more serving cells comprise the first serving cell. Referring to FIG. 4, the first serving cell may be serving cell 410 or serving cell 420.

In some example embodiments, if a second serving cell is is configured with uplink scheduling information of PUCCH for the terminal device 110 but not configured with uplink scheduling information of PUSCH for the terminal device 110, the terminal device 110 may determine that the one or more serving cells do not comprise the second serving cell. Referring to FIG. 4, the second serving cell may be serving cell 420.

In some embodiments, if a third serving cell is configured to schedule a fourth serving cell, where the fourth serving cell is configured with uplink scheduling information of PUSCH for the terminal device 110 and where the third serving cell is configured with downlink scheduling information of PDCCH for the terminal device 110, the terminal device 110 may determine that the one or more serving cells comprise the third serving cell. Referring to FIG. 4, the third serving cell may be serving cell 440 and the fourth serving cell may be serving cell 430.

In some embodiments, if a fifth serving cell is not configured with uplink scheduling information for the terminal device 110, the terminal device 110 may determine that the one or more serving cells does not comprise the fifth serving cell. Referring to FIG. 4, the fifth serving cell may be serving cell 450.

By referring to FIG. 4, in some example embodiments, the one or more serving cells determined by the terminal device 110 may comprise serving cell 410, serving cell 420, and serving cell 440; in some other example embodiments, the one or more serving cells determined by the terminal device 110 may comprise serving cell 410 and serving cell 440.

The terminal device 110 monitors 350 PDCCH from the one or more serving cells determined at 340. In this way, the terminal device 110 ignores the PDCCH skipping on the one or more serving cells. In some example embodiments, the PDCCH monitoring is restored or started for one or more serving cells each is associated with UL carrier.

In some embodiments, the terminal device 110 may continue applying or performing the PDCCH skipping on other serving cell(s) in the at least one serving cell. Therefore, the terminal device 110 does not monitor PDCCH from other serving cell(s) regardless of the pending SR.

In some example embodiments, the one or more serving cells include serving cell 410 and serving cell 440, and other serving cells in the at least one serving cell include serving cell 420 and serving cell 450, as shown in FIG. 4.

Alternatively, or in addition, in some example embodiments, the network device 120 may determine 352 one serving cell from the at least one serving cell to transmit an uplink grant after receiving a scheduling request from the terminal device 110. In some example embodiments, the network device 120 may determine one or more serving cells based on the characteristics of the plurality of serving cells and the network device 120 may choose one serving cell, from the determined one or more serving cells.

The network device 120 transmits 360 an uplink grant over PDCCH on a serving cell. In some example embodiments, the uplink grant may be transmitted over PDCCH of the serving cell determined at 352. In this regard, although PDCCH skipping is configured, the network device 120 may overrule its decision and transmit the uplink grant, based on the SR received at 330.

Accordingly, the terminal device 110 may receive the uplink grant in the monitored PDCCH from one serving cell of one or more serving cells. Further, the terminal device 110 may perform 370 an uplink transmission based on the uplink grant. Accordingly, the network device 120 may receive the uplink transmission on the scheduled uplink grant.

Alternatively, or in addition, in some example embodiments, the terminal device 110 may continue 380 to monitor PDCCH from the one or more serving cells determined at 340. Alternatively, or in addition, in some example embodiments, the terminal device 110 may continue to monitor PDCCH from other serving cells. In this event, the terminal device 110 may monitor PDCCH from all serving cells, even within the predetermined time duration.

Alternatively, or in addition, in some example embodiments, the terminal device 110 may continue 380 to monitor PDCCH from the one or more serving cells determined at 340. Alternatively, or in addition, in some example embodiments, the terminal device 110 may continue to apply or perform the PDCCH skipping on other serving cells. In this event, the terminal device 110 may continue monitoring PDCCH from the one or more serving cells and continue applying or performing PDCCH skipping on other serving cells. In other words, the SR transmission or the uplink grant transmission or the uplink transmission does not affect the PDCCH skipping on other serving cells.

It is noted that the process 380 in FIG. 3 is shown after the process 370, however, it is shown only for the purpose of illustration without suggesting any limitation as to the scope of the disclosure, for example, in some scenarios, the process 380 is based on the act at 360.

With reference to FIG. 4, it is assumed that the one or more serving cells include serving cell 410 and serving cell 440, and other serving cells in the at least one serving cell include serving cell 420 and serving cell 450.

It is assumed that the SR is triggered at TO and the SR is transmitted at T1. Further, the uplink grant is received at T2 and the uplink transmission is performed at T3.

In some embodiments, the PDCCH skipping on serving cell 410 is ignored from TO (shown as 412) or from T1 (shown as 414), and the PDCCH skipping on serving cell 440 is ignored from TO (shown as 442) or from T1 (shown as 444).

In some embodiments, the PDCCH skipping on serving cells 420 and 450 are applied all the time (not shown in FIG. 4). In some example embodiments, the PDCCH skipping on serving cells 420 and 450 are applied until T2 or T3. In other words, the PDCCH skipping on serving cell 420 is ignored from T2 (shown as 422) or from T3 (shown as 424), and the PDCCH skipping on serving cell 420 is ignored from T2 (shown as 452) or from T3 (shown as 454).

Based on the embodiments described above, the terminal device 110 may determine whether to continue applying or performing PDCCH skipping on each serving cell by considering the UL scheduling possibility. It is understood that the terminal device 110 continues to apply or perform the PDCCH skipping on the serving cell(s) without UL configuration information, since it is impossible to schedule uplink grant from these serving cells. Therefore, there is no need for the terminal device 110 to ignore the PDCCH skipping on all serving cells, and the UE power saving can be achieved since the PDCCH skipping is still applied on some of the serving cells.

It is to be understood that some acts as in FIG. 3 are similar as those described with reference to FIG. 2 and thus are not repeatedly described in detail here. It is also to be understood that although the example processes 200 and 300 are described separately, aspects of the two processes may be combined. It is also to be understood that the example processes 200 and 300 are described only for the purpose of illustration and help those skilled in the art to understand and implement the present disclosure, without suggesting any limitation as to the scope of the disclosure. The disclosure described herein can be implemented in various manners other than the ones described above.

### Example Methods

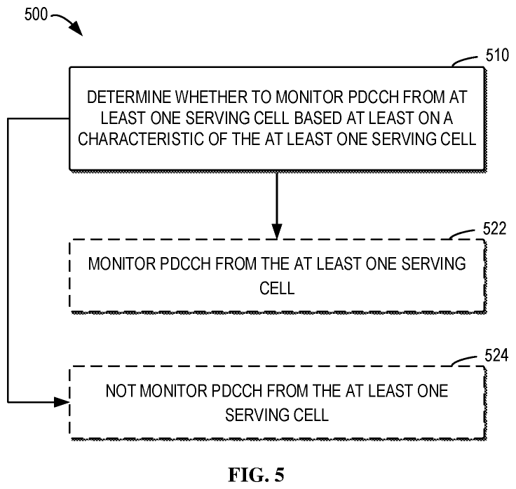

FIG. 5 shows a flowchart of an example method 500 in accordance with some example embodiments of the present disclosure. The method 500 can be implemented at the terminal device 110 as shown in FIG. 1.

At block 510, if a scheduling request is triggered or a scheduling request is transmitted, the terminal device 110 determines whether to monitor PDCCH from at least one serving cell based at least on a characteristic of the at least one serving cell.

In some example embodiments, at block 522, the terminal device 110 monitors PDCCH from the at least one serving cell if the at least one serving cell is, or has a characteristic that corresponds to, at least one of:
(1) a serving cell with a configured uplink,
(2) a serving cell with a PUSCH configuration,
(3) a serving cell which provides an uplink grant over a monitored PDCCH, or
(4) a serving cell with a PDCCH which is associated with another serving cell with a configured uplink or a PUSCH configuration.

In some example embodiments, the terminal device 110 may receive a PDCCH skipping configuration associated with the at least one serving cell, where the PDCCH skipping configuration comprises a predetermined time duration; and may apply or perform the PDCCH skipping according to the PDCCH skipping configuration for the predetermined time duration.

In some example embodiments, the terminal device 110 may monitor PDCCH from the at least one serving cell by ignoring the PDCCH skipping on the at least one serving cell.

In some example embodiments, the terminal device 110 may receive, from one serving cell of the at least one serving cell, an uplink grant over the monitored PDCCH for an uplink transmission.

In some example embodiments, the terminal device 110 may continue to monitor the PDCCH from the at least one serving cell if the uplink grant is received or the uplink transmission is performed based on the grant.

In some example embodiments, at block 524, the terminal device 110 does not monitor PDCCH from the at least one serving cell if the at least one serving cell is not, or has a characteristic that does not correspond to, any one of:
(1) a serving cell with a configured uplink,
(2) a serving cell with a physical uplink shared channel (PUSCH) configuration,
(3) a serving cell which provides an uplink grant over a monitored PDCCH, or
(4) a serving cell with a PDCCH which is associated with another serving cell with a configured uplink or a PUSCH configuration.

In some example embodiments, the terminal device 110 may apply or perform PDCCH skipping to not monitor PDCCH from the at least one serving cell.

In some example embodiments, the terminal device 110 may monitor the PDCCH from the at least one serving cell if the uplink grant is received from a serving cell rather than the at least one serving cell or if an uplink transmission is performed based on the uplink grant.

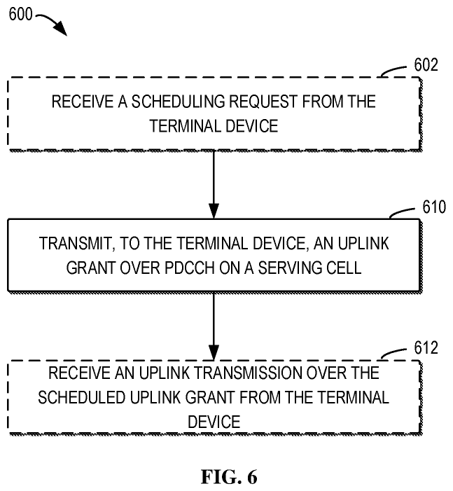

FIG. 6 shows a flowchart of an example method 600 in accordance with some example embodiments of the present disclosure. The method 600 can be implemented at the network device 120 as shown in FIG. 1.

At block 610, if a scheduling request is received from a terminal device, the network device 120 transmits, to the terminal device, an uplink grant over PDCCH on a serving cell by ignoring PDCCH skipping on the serving cell.

Alternatively, or in addition, in some example embodiments, the network device 120 may configure PDCCH skipping on serving cells which comprise the serving cell will transmitting the uplink grant.

In some example embodiments, at block 602, the network device 120 may receive a scheduling request from the terminal device.

In some example embodiments, the serving cell is, or has a characteristic corresponding to, one of:
(1) a serving cell with a configured uplink,
(2) a serving cell with a physical uplink shared channel (PUSCH) configuration,
(3) a serving cell which provides an uplink grant over a monitored PDCCH, or
(4) a serving cell with a PDCCH which is associated with another serving cell with a configured uplink or a PUSCH configuration.

In some example embodiments, at block 612, the network device 120 may receive an uplink transmission over the scheduled uplink grant from the terminal device 110.

### Example Apparatuses

In some example embodiments, an apparatus capable of performing the method 500 may comprise means for performing the respective operations of the method 500. The means may be implemented in any suitable form. For example, the means may be implemented in a circuitry or software module. In some embodiments, the means may comprise at least one processor and at least one memory. The apparatus may be implemented as or included in the terminal device 110.

In some example embodiments, the apparatus comprises: means for in accordance with a determination that a scheduling request is triggered or a scheduling request is transmitted, determining whether to monitor PDCCH from at least one serving cell based on a characteristic of the at least one serving cell associated with an uplink of the at least one serving cell.

In some example embodiments, the apparatus comprises: means for monitoring PDCCH from the at least one serving cell when the characteristic of the at least one serving cell correspond to one of: a serving cell with a configured uplink, a serving cell with a PUSCH configuration, a serving cell which provides an uplink grant over a monitored PDCCH, or a serving cell with a PDCCH which is associated with another serving cell with a configured uplink or a PUSCH configuration.

In some example embodiments, the apparatus comprises: means for receiving a PDCCH skipping configuration associated with the at least one serving cell, the PDCCH skipping configuration comprises a predetermined time duration; and means for applying or performing PDCCH skipping according to the PDCCH skipping configuration for the predetermined time duration.

In some example embodiments, the apparatus comprises: means for monitoring PDCCH from the at least one serving cell by ignoring the PDCCH skipping on the at least one serving cell.

In some example embodiments, the apparatus comprises: means for receiving, from one serving cell of the at least one serving cell, an uplink grant over the monitored PDCCH for an uplink transmission.

In some example embodiments, the apparatus comprises: means for in accordance with a reception of the uplink grant or in accordance with an uplink transmission performed based on the uplink grant, continuing to monitor the PDCCH from the at least one serving cell.

In some example embodiments, the apparatus comprises: means for not monitoring PDCCH from the at least one serving cell when the type or the characteristic of the at least one serving cell does not correspond to any one of: a serving cell with a configured uplink, a serving cell with a PUSCH configuration, a serving cell which provides an uplink grant over a monitored PDCCH, or a serving cell with a PDCCH which is associated with another serving cell with a configured uplink or a PUSCH configuration.

In some example embodiments, the apparatus comprises: means for applying or performing the PDCCH skipping to not monitor PDCCH from the at least one serving cell.

In some example embodiments, the apparatus comprises: means for in accordance with a reception of the uplink grant from a serving cell rather than the at least one serving cell or in accordance with an uplink transmission performed based on the uplink grant, monitoring the PDCCH from the at least one serving cell.

In some example embodiments, an apparatus capable of performing the method 600 may comprise means for performing the respective operations of the method 600. The means may be implemented in any suitable form. For example, the means may be implemented in a circuitry or software module. In some embodiments, the means may comprise at least one processor and at least one memory. The apparatus may be implemented as or included in the network device 120.

In some example embodiments, the serving cell is one of: a serving cell with a configured uplink, a serving cell with a PUSCH configuration, a serving cell which provides an uplink grant over a monitored PDCCH, or a serving cell with a PDCCH which is associated with another serving cell with a configured uplink or a PUSCH configuration.

In some example embodiments, the apparatus comprises: means for receiving, from the terminal device, an uplink transmission over the uplink grant.

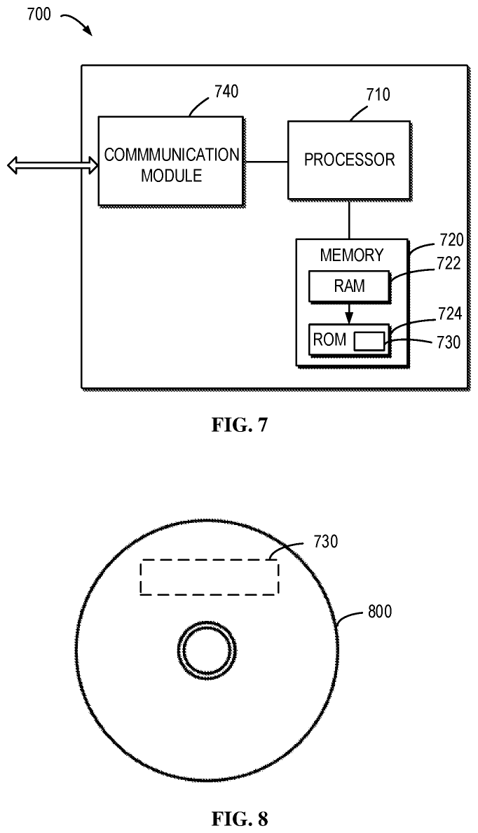

FIG. 7 is a simplified block diagram of a device 700 that is suitable for implementing embodiments of the present disclosure. For example, the terminal device 110 or the network device 120 shown in FIG. 1 may be implemented by the device 700. As shown, the device 700 includes one or more processors 710, one or more memories 720 coupled to the processor 710, and one or more communication modules 740 coupled to the processor 710.

The communication module 740 is for communications with other device(s). The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital versatile disc (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2-6. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

It should be appreciated that future networks may utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications, this may mean node operations to be carried out, at least partly, in a central/centralized unit, CU, (e.g. server, host or node) operationally coupled to distributed unit, DU, (e.g. a radio head/node). It is also possible that node operations will be distributed among a plurality of servers, nodes or hosts. It should also be understood that the distribution of labour between core network operations and base station operations may vary depending on implementation.

In an embodiment, the server may generate a virtual network through which the server communicates with the distributed unit. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU and the boundary where the responsibility is shifted between the CU and the DU may be selected according to implementation.

Therefore, in an embodiment, a CU-DU architecture is implemented. In such case the device 700 may be comprised in a central unit (e.g. a control unit, an edge cloud server, a server) operatively coupled (e.g. via a wireless or wired network) to a distributed unit (e.g. a remote radio head/node). That is, the central unit (e.g. an edge cloud server) and the distributed unit may be stand-alone apparatuses communicating with each other via a radio path or via a wired connection. Alternatively, they may be in a same entity communicating via a wired connection, etc. The edge cloud or edge cloud server may serve a plurality of distributed units or a radio access networks. In an embodiment, at least some of the described processes may be performed by the central unit. In another embodiment, the device 700 may be instead comprised in the distributed unit, and at least some of the described processes may be performed by the distributed unit.

In an embodiment, the execution of at least some of the functionalities of the device 700 may be shared between two physically separate devices (DU and CU) forming one operational entity. Therefore, the apparatus may be seen to depict the operational entity comprising one or more physically separate devices for executing at least some of the described processes. In an embodiment, such CU-DU architecture may provide flexible distribution of operations between the CU and the DU. In practice, any digital signal processing task may be performed in either the CU or the DU and the boundary where the responsibility is shifted between the CU and the DU may be selected according to implementation. In an embodiment, the device 700 controls the execution of the processes, regardless of the location of the apparatus and regardless of where the processes/functions are carried out.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 500, or 600 as described above with reference to FIGS. 5-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory including computer program codes;
the at least one memory and the computer program codes are configured to, with the at least one processor, cause the terminal device to:
in accordance with a determination that a scheduling request is triggered or a scheduling request is transmitted, determine whether to monitor physical downlink control channel (PDCCH) from at least one serving cell based on a characteristic of the at least one serving cell associated with an uplink of the at least one serving cell.

2. The terminal device of claim 1, wherein the at least one memory and the computer program codes are configured to, with the at least one processor, to cause the terminal device to:
monitor PDCCH from the at least one serving cell when the characteristic of the at least one serving cell corresponds to one of:
a serving cell with a configured uplink,
a serving cell with a physical uplink shared channel (PUSCH) configuration,
a serving cell which provides an uplink grant over a monitored PDCCH, or
a serving cell with a PDCCH which is associated with another serving cell with a configured uplink or a PUSCH configuration.

3. The terminal device of claim 2, wherein the at least one memory and the computer program codes are configured to, with the at least one processor, to cause the terminal device to:
receive a PDCCH skipping configuration associated with the at least one serving cell, the PDCCH skipping configuration comprising a predetermined time duration; and
perform PDCCH skipping according to the PDCCH skipping configuration for the predetermined time duration.

4. The terminal device of claim 3, wherein the at least one memory and the computer program codes are configured to, with the at least one processor, to cause the terminal device to monitor PDCCH from the at least one serving cell by ignoring the PDCCH skipping on the at least one serving cell.

5. The terminal device of claim 2, wherein the at least one memory and the computer program codes are configured to, with the at least one processor, to cause the terminal device to:
receive, from one serving cell of the at least one serving cell, an uplink grant over the monitored PDCCH for an uplink transmission.

6. The terminal device of claim 2, wherein the at least one memory and the computer program codes are configured to, with the at least one processor, to cause the terminal device to:
in accordance with a reception of the uplink grant or in accordance with an uplink transmission performed based on the uplink grant, continue to monitor the PDCCH from the at least one serving cell.

7. The terminal device of claim 1, wherein the at least one memory and the computer program codes are configured to, with the at least one processor, to cause the terminal device to:
not monitor PDCCH from the at least one serving cell when the characteristic of the at least one serving cell does not correspond to any one of:
a serving cell with a configured uplink,
a serving cell with a physical uplink shared channel (PUSCH) configuration,
a serving cell which provides an uplink grant over a monitored PDCCH, or
a serving cell with a PDCCH which is associated with another serving cell with a configured uplink or a PUSCH configuration.

8. The terminal device of claim 7, wherein the at least one memory and the computer program codes are configured to, with the at least one processor, to cause the terminal device to:
perform PDCCH skipping to not monitor PDCCH from the at least one serving cell.

9. The terminal device of claim 7, wherein the at least one memory and the computer program codes are configured to, with the at least one processor, to cause the terminal device to:
in accordance with a reception of the uplink grant from a serving cell other than the at least one serving cell or in accordance with an uplink transmission performed based on the uplink grant, monitor the PDCCH from the at least one serving cell.

10. A network device comprising:
at least one processor; and
at least one memory including computer program codes;
the at least one memory and the computer program codes are configured to, with the at least one processor, cause the network device to:
in accordance with a reception of a scheduling request from a terminal device, transmit, to the terminal device, an uplink grant over a physical downlink control channel (PDCCH) on a serving cell by ignoring PDCCH skipping on the serving cell.

11. The network device of claim 10, wherein the serving cell is one of:
a serving cell with a configured uplink,
a serving cell with a physical uplink shared channel (PUSCH) configuration,
a serving cell which provides an uplink grant over a monitored PDCCH, or
a serving cell with a PDCCH which is associated with another serving cell with a configured uplink or a PUSCH configuration.

12. The network device of claim 10, wherein the at least one memory and the computer program codes are configured to, with the at least one processor, cause the network device to:
receive, from the terminal device, an uplink transmission over the uplink grant.

13. A method, comprising:
in accordance with a determination that a scheduling request is triggered or a scheduling request is transmitted, determining, at a terminal device, whether to monitor physical downlink control channel (PDCCH) from at least one serving cell based on a characteristic of the at least one serving cell associated with an uplink of the at least one serving cell.

14. A method comprising:
in accordance with a reception of a scheduling request from a terminal device, transmitting, from a network device and to the terminal device, an uplink grant over a physical downlink control channel (PDCCH) on a serving cell by ignoring PDCCH skipping on the serving cell.

15-17. (canceled)
